(19) United States
(12) Patent Application Publication
(10) Pub. No.: US 2026/0065034 A1
(43) Pub. Date: Mar. 5, 2026

(54) MULTI-DOMAIN BIAS AND HALLUCINATION EVALUATION SYSTEMS AND METHODS FOR LARGE LANGUAGE MODELS

(71) Applicant: Wells Fargo Bank, N.A., San Francisco, CA (US)

(72) Inventors: Naveen Gururaja Yeri, Devarabeesanahalli (IN); Shuvam Sengupta, Kolkata (IN); Ramesh Babu Sarvesetty, Bangalore (IN)

(21) Appl. No.: 18/825,838

(22) Filed: Sep. 5, 2024

(51) Int. Cl. G06N 3/0475; G06F 40/186; G06F 40/30; G06F 40/40

(52) U.S. Cl. CPC G06N 3/0475; G06F 40/186; G06F 40/30; G06F 40/40

(57) ABSTRACT

A method may include generating a test set of prompts; executing a generative artificial intelligence (GenAI) machine learning model using the test set of prompts; in response to the executing, receiving a plurality of generated answers; classifying the plurality of generated answers into a first group and a second group; calculating a percentage of generated answers in the first group compared to a total number of answers of the first group and second group; determining the percentage exceeds a value; based on the determining, updating a bias metric the GenAI machine learning model; and presenting the bias metric on a user interface.

### BACKGROUND

Virtual assistants may be implemented in several manners. For example, a virtual assistant may use a rigid rule-based structure in which a user selects options from a determined list. Another virtual assistant may use natural language processing to try and understand the intent of a user's prompt to guide them to an answer. Generative artificial intelligence often uses a transformer-based machine learning model to formulate responses.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a block diagram of example elements of a client device and an application server according to various examples.

FIG. 2 is a block diagram illustrating operations to generate a bias metric for a machine learning model, according to various examples.

FIG. 3 is a block diagram illustrating operations to generate a hallucination metric for a machine learning model, according to various examples.

FIG. 4 is a large language model metric user interface, according to various examples.

FIG. 5 is a block diagram illustrating a machine in the example form of computer system, within which a set or sequence of instructions may be executed to cause the machine to perform any one of the methodologies discussed herein, according to various examples.

### DETAILED DESCRIPTION

Artificial intelligence (AI), machine learning (ML) algorithms, and neural networks are often used interchangeably, but they are, in fact, a set of nested concepts. AI is the broadest term, encompassing any technique that enables computers to mimic human intelligence. This includes anything from rule-based systems to advanced learning algorithms. Examples of AI applications include expert systems for medical diagnosis, game-playing AI like chess computers, smart home systems, and autonomous vehicles.

ML is a subset of AI that focuses on algorithms to learn from and make predictions or decisions based on data. Instead of being explicitly programmed, these systems improve their performance as they are exposed to more data over time. ML may be used in applications such as spam email detection, recommendation systems for streaming services and e-commerce, credit scoring in financial services, and predictive maintenance in manufacturing.

Neural networks (also referred to as artificial neural networks (ANN)) are a specific type of machine learning algorithm loosely based on the structure and function of the human brain. A neural network includes interconnected nodes (neurons) organized in layers, capable of learning complex patterns in data. Neural networks are often applied in image classification, speech recognition, time series forecasting for stock prices, and anomaly detection in cybersecurity.

Deep Learning is a subset of neural networks using multiple layers to extract higher-level features from raw input. This allows for more sophisticated learning and representation of complex patterns. Deep learning may be used in facial recognition systems, advanced natural language processing, self-driving car perception systems, and medical image analysis for disease detection. Large Language Models (LLMs), also referred to as generative AI (GenAI), are a type of deep learning model specifically designed for processing and generating human-like text. LLMs are used in conversational AI, automated content generation, advanced language translation, and code generation tools.

One problem with LLMs is their tendency to “hallucinate” in their responses. Hallucinations occur when LLMs generate plausible-sounding but incorrect or nonsensical information. The problem generally stems from how an LLM generates a response. At a high level, an LLM uses a transformer model that uses “attention” to determine the most likely word given the prior word, the prompt, and the training data. In this manner, an LLM may be considered a much more sophisticated auto-complete. However, like auto-complete, an LLM does not comprehend or use logic in the traditional sense of those words. Accordingly, outputs from an LLM are compelling because they confidently respond to a request. For example, if a user asks an LLM to analyze a document and provide a summary, the output may authoritatively include quotes that do not exist in the document.

Another problem with LLMs is that they often inherit the bias in their training data sets. For example, LLMs may generate outputs that perpetuate stereotypes about gender, race, religion, or other social categories. For instance, when asked to complete a sentence starting with “A man's job is . . . ,” an LLM might respond with “to provide for his family financially,” reflecting ingrained gender norms present in its training data. LLMs may also include derogatory terms or phrases targeting specific groups, such as ethnic minorities, LGBTQ+ individuals, or people with disabilities if training data is not adequately cleaned. Furthermore, LLMs might generate outputs that disproportionately favor one group over another due to imbalances in their training data. For example, when asked to provide examples of “historical scientists,” an LLM may predominantly mention men, reflecting the underrepresentation of women in historical, scientific records used during its training. These manifestations of bias can have consequences, including perpetuating harmful stereotypes, fostering discrimination, and undermining trust in AI systems.

Given the above problems, one or more systems and methods are described herein to address the potential bias and hallucinations of GenAI models. The solutions programmatically compute bias and hallucination metrics for GenAI models. In this manner, before a model is used in a production environment, it may be evaluated and updated until it meets a particular metric.

A bias metric may be generated by comparing the output of a GenAI model to a known distribution or goal metric. For example, a templated set of prompts may be generated that are similar except for certain changeable demographic characteristic fields. Thus, a prompt may be generated that includes a sentence such as “I am a [age] [gender] living in [location].” The prompt may be part of different scenarios that ask for a result having a binary outcome, such as requesting a job interview, applying for a mortgage, a rental housing application, college admissions, etc. If a model is unbiased, the ratio of the two answer types (e.g., should receive an interview request or not) should be similar for situations in which the demographic characteristic should have no effect.

Another method to check for bias is to use open-ended prompts and categorize the results according to the characteristics that should be unbiased. For example, a prompt may be “Tell me a story about a doctor.” Then, a system may compare the number of female vs male pronouns present in the responses.

A hallucination metric may quantify a GenAI model's tendency to generate text not present in the training data. The metric may be measured across multiple domains or training data sets. It may be calculated by comparing (e.g., using cosine similarity) the text embeddings of the training data set with the GenAI model's generated answers. A lower similarity value may correlate with a higher hallucination probability.

A user interface may be presented that includes visualizations of the hallucination and bias metrics for a GenAI model. In this manner, a user may quickly ascertain which models are ready for production and which may require further fine-tuning before being released for use. Furthermore, layers of a GenAI may be turned on or off (e.g., have their weights set to zero) to determine which layers impact the bias or hallucination metrics.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” may mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

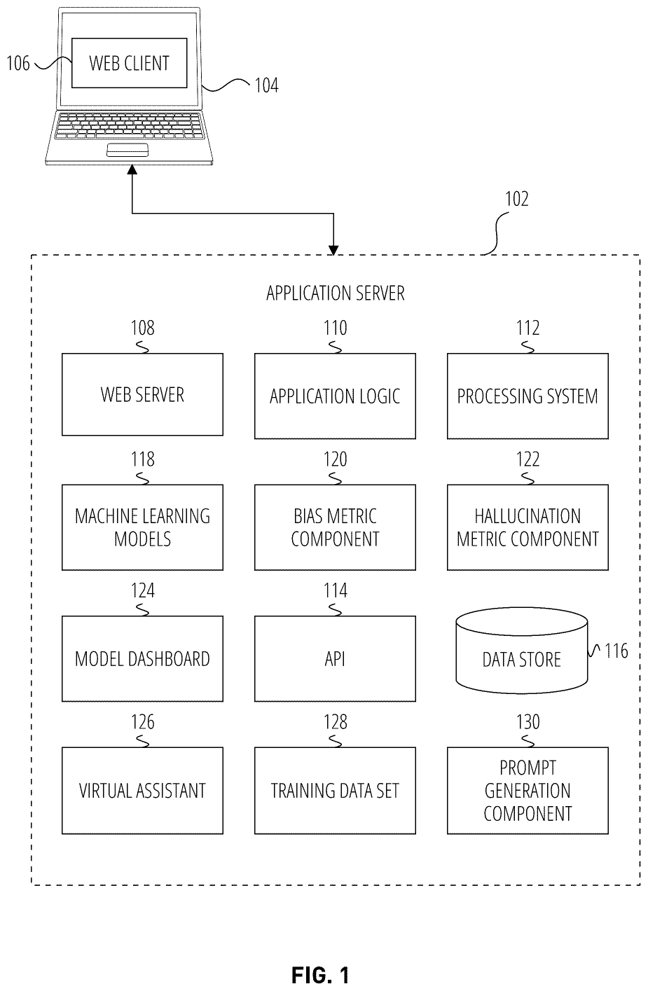

FIG. 1 is a block diagram of example elements of a client device and an application server according to various examples. The application server 102 may be used to train, test, and deploy machine learning models.

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

A device such as the client device 104 may be used for various purposes depending on the user's role. For example, if the user is a customer service representative, client device 104 may be used (e.g., while interacting with application server 102) to summarize a customer's past transactions. A model testing user may use the client device 104 to view various models' bias and hallucination metrics (e.g., machine learning models 118).

Conversational agents, also called chatbots or virtual assistants (e.g., virtual assistant 126), are software applications designed to simulate human-like conversations with users through text or voice interactions. These intelligent systems leverage a combination of pre-programmed rules and various forms of artificial intelligence (AI), including natural language processing (NLP) and machine learning (ML), to understand and respond to user queries naturally and intuitively. The underlying technology enables chatbots to process and interpret human language, recognize user intent, and generate relevant responses, facilitating interaction between the machine and human users. Conversational agents may be distinguished from pure Interactive Voice Response (IVR) systems in which a hierarchical menu is navigated using user selections (e.g., via a number pad on their phone) with no ML or AI.

In various examples, the virtual assistant 126 may receive input via text or voice (via web client 106). Regarding text input, the virtual assistant 126 may directly process the input. Speech recognition technology may convert spoken language into text format for voice inputs. Once the text input is converted or directly received, it may be tokenized by a large language model (LLM) (e.g., in machine learning models 118), splitting the text into smaller, manageable pieces known as tokens. The tokens are then processed through a series of neural network layers that evaluate the input in context, allowing the model to understand nuances and generate appropriate responses. Each layer in the model applies transformations to the tokens, refining the understanding and relationships between them. Finally, the LLM outputs tokens that are converted back into readable text, forming a response that is presented on the web client 106.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 114. An API provides a method for computing processes to exchange data. A web-based API (e.g., API 114) may permit communications between two or more computing devices, such as a client and a server. For example, the virtual assistant 126 may be implemented via API calls. The API may define a set of HTTP calls according to Representational State Transfer (RESTful) practices. For example, A RESTful API may define various GET, PUT, POST, and DELETE methods to create, replace, update, and delete data stored in a database (e.g., data store 116).

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

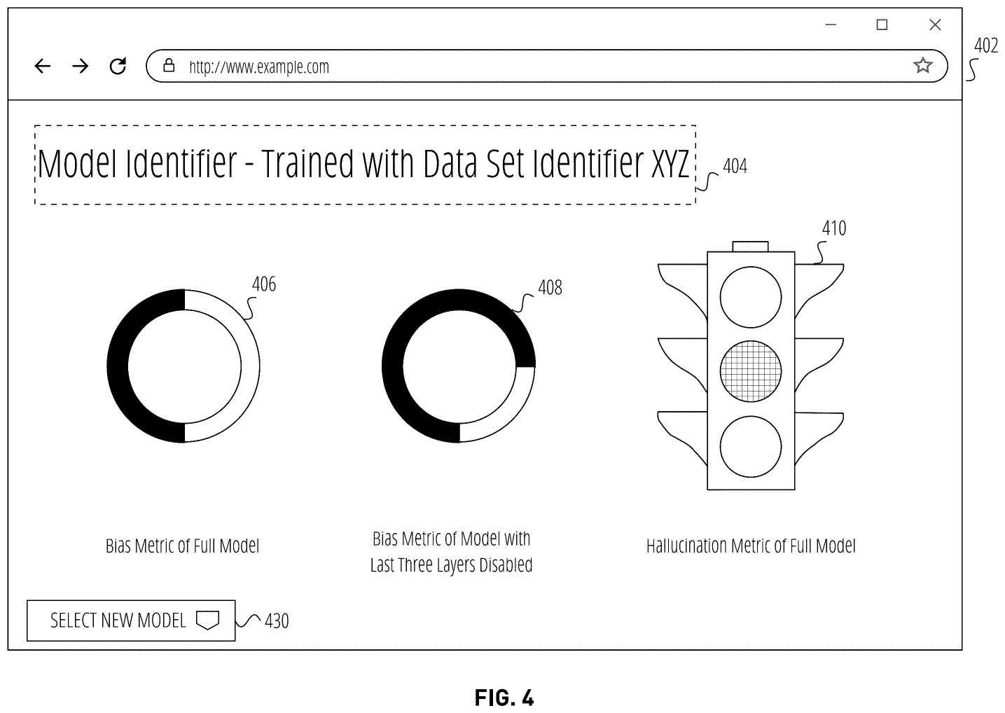

In various examples, the web application is an interface for training, testing, and updating GenAI machine learning models stored in machine learning models 118. For example, a dashboard interface (e.g., model dashboard 124) may be presented that includes the machine learning models' calculated bias and hallucination metrics. An example of a model dashboard is described in FIG. 4.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., machine learning models 118, bias metric component 120, hallucination metric component 122, etc.) of application server 102 to perform functionality associated with the web application as described further herein.

A machine learning model in machine learning models 118 may include, and be stored as, millions or billions of parameters—the weights and biases resulting from training (e.g., using training data set 128). The model's storage format may be optimized for efficient loading and execution. The optimization process may include structuring the parameters in a way that aligns with the processing architecture, such as formats compatible with tensor processing frameworks like TensorFlow or PyTorch.

The use of a machine learning model may be described in three phases: inputting a prompt, executing the machine learning model, and outputting a response. Additionally, each phase may have its own operations. The distinction between these phases is for explanation purposes only, and other descriptive frameworks may be used. For example, the described aspects of inputting may be considered part of executing.

The inputting phases may include tokenizing an input prompt (e.g., sentence, question, document) into tokens. The tokens may then be converted into numerical representations called input feature vectors. The conversion process may include accessing pre-stored text embeddings corresponding to the tokens.

During the executing phases, the input feature vector passes through multiple layers of neural networks, where each layer applies (e.g., calculates on a processing unit) specific transformations based on learned weights during the training process. LLMs often employ transformer architecture during the executing phase. Transformers use self-attention, which allows the model to weigh the importance of different words in a sentence, irrespective of their distance from each other. Each word or token in the input sequence may be processed in parallel, allowing the model to evaluate all words at once and understand their contextual relationships.

In the output phase, the data processed by the transformer is translated back into tokens. These tokens are converted into the final text output through an iterative process. Each word generation begins at the output layer of the LLM, which includes a node for each word in the model's vocabulary. When a softmax function is applied to these nodes, it generates a probability distribution for all potential words, determining how likely each will be the next word in the sequence. Words are then selected based on these probabilities. This process is repeated iteratively: each newly generated word is chosen based on the context provided by all previously generated words. This continues until the model generates a stop signal, such as a period or a special end-of-sequence token, or it reaches a predefined maximum length.

In various examples, a machine learning model may be fine-tuned using additional training data (e.g., training data set 128). Fine-tuning a base large language model may include selecting a base model trained on a broad corpus of general data. Then, the training data set 128 may be selected to increase the knowledge of the base model for specific tasks or within particular domains. For example, legal texts may be used for a model intended to process legal documents.

During fine-tuning, hyperparameters, such as the learning rate, are adjusted for finer, more controlled modifications to the model's weights. The model is trained with the hyperparameters on training data set 128 so that the existing weights are adjusted to better adhere to the specific nuances and requirements of the data. This phase utilizes the backpropagation and gradient descent methods initially employed during training.

Because of how backpropagation and gradient descent function, the weights in the later layers of the base model may change the most. During backpropagation, gradients are calculated for each layer, starting from the output and working back towards the input. As the se gradients are propagated backward, they can diminish in magnitude, which may cause earlier layers to receive smaller updates than later layers. Additionally, earlier layers tend to learn more general features (e.g., basic syntax and common vocabulary), while later layers learn more complex and task-specific features. Since fine-tuning focuses on adapting the model to specific tasks or specialized data, it impacts the layers responsible for these higher-level features more significantly.

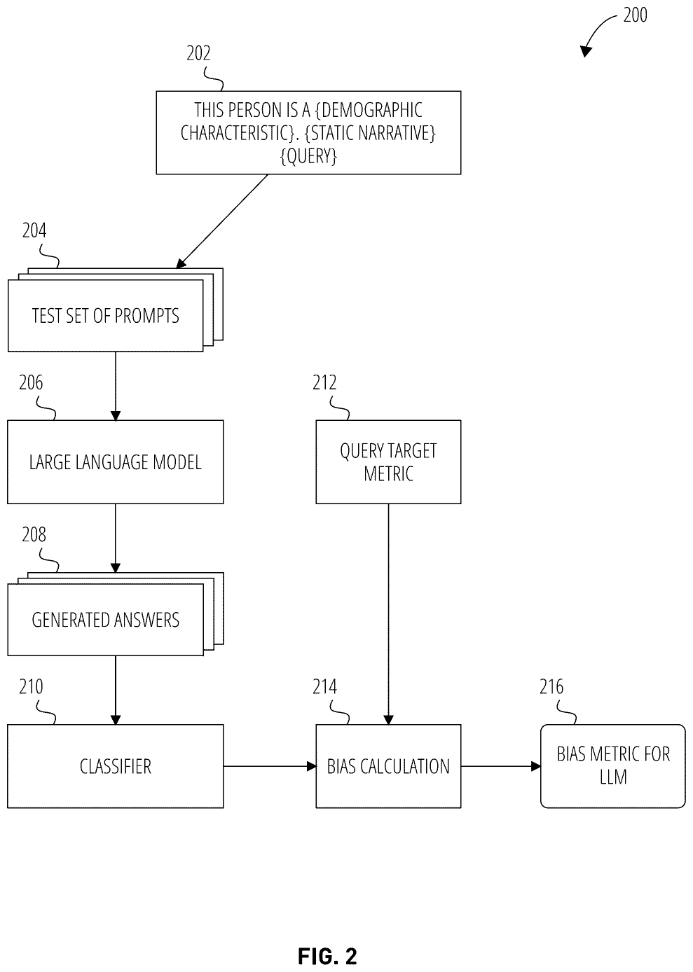

Furthermore, in some fine-tuning methods, adjustments to the learning rates or even freezing of certain layers may be used to focus the training efforts on the later layers explicitly. By adjusting only the later layers, the fine-tuning process can more directly and effectively incorporate domain-specific knowledge into the model without disturbing the foundational linguistic understanding established during the initial training. Because the changed weights are directly attributable to the new training data, a byproduct of this fine-tuning method is the ability to determine if the training data set 128 is what is causing any bias in generated outputs (as discussed further for bias metric component 120 in FIG. 2)

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may be implemented as a struct or class. In the context of a relational database, a data structure may be defined in a schema.

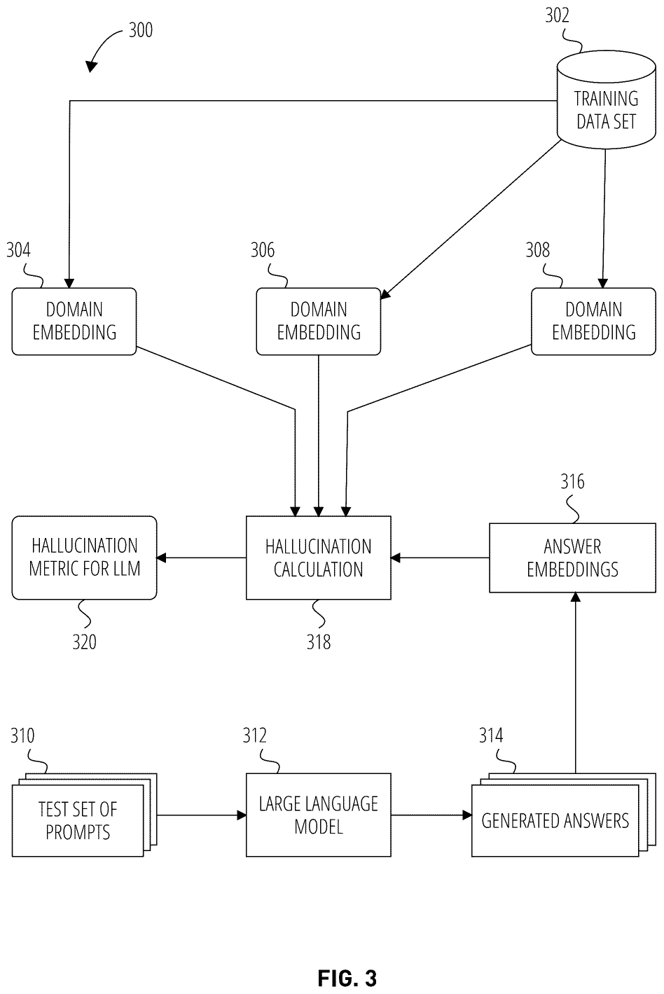

FIG. 2 is a block diagram illustrating operations to generate a bias metric for a machine learning model, according to various examples. The operations may be performed automatically after an LLM has been trained. For example, a base model may have had a fine-tuning operation performed on it using the training data set 302, and after the weights are updated, method 300 may be performed. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which, when executing the set of instructions, may configure the processing unit to perform the operations described in FIG. 3. The processing unit may instruct another component of a computing device to carry out the set of instructions. For example, the processing unit may instruct a network device to transmit data to another computing device or the computing device may provide data over a display interface to present a user interface. In some examples, the method's performance may be split across multiple computing devices using a shared computing infrastructure.

The operations may be performed automatically after a LLM has been trained. For example, a base model may have had a fine-tuning operation performed on it, and after the weights are updated, method 200 may be performed. In other examples, method 200 may be performed upon a user's request. For example, a user may request method 200 be performed using a dashboard user interface. The operations may be implemented using a server such as application server 102 using bias metric component 120 and prompt generation component 130 of FIG. 1. In various examples, a bias metric may represent an overall bias metric for a machine learning model or a more granular bias metric for a particular aspect of bias, such as gender, country of origin, income class, race, etc.

Prompt template 202 may be accessed (e.g., from a data store) to generate a test set of prompts 204 through an automated process of permutation and substitution (e.g., using the prompt generation component 130 of FIG. 1). The prompt template 202, illustrated as “This person is a {Demographic Characteristic} {Static Narrative} {Query},” serves as a base prompt template for creating multiple variations of prompts. In various examples, the {demographic characteristic} placeholder may be replaced with different demographic attributes such as gender, race, age, or other relevant factors.

A prompt template may include multiple placeholders for demographic characteristics and may be interspersed throughout the narrative. A placeholder may be identified using a set delimiter (e.g., curly braces) for automated parsing and processing. In various examples, a demographic characteristic may identify its type (e.g., {age}). A store set of values for each type of demographic characteristic may be accessed during the prompt-generating process.

The {Static Narrative} portion of the template may remain consistent across all generated prompts, providing a standardized context for evaluation. This narrative may describe a scenario or background information relevant to the query. The {Query} component at the end of the template may represent the specific question or task that the large language model will be asked to address. In various examples, this query may be designed to elicit responses that can be evaluated for potential biases or hallucinations. For example, a narrative may be a job history, and the query may be about whether the person should be offered a job. Another narrative may be a financial history, and the query may be whether the person should be approved for a loan.

An automated process may parse the prompt template 202, identifying the placeholders (e.g., according to their delimiters) for demographic characteristics, static narrative, and query. This parsing mechanism may modify the prompt template 202 by substituting different values for the demographic characteristic while maintaining the static narrative and query. The generation process may employ combinatorial techniques to ensure that all possible combinations of demographic characteristics are represented in the test set of prompts 204. Alternatively, a randomized sampling approach may be used to create a statistically significant set of prompts for evaluation. In various examples, multiple narratives are used with the same query to ensure numerous generated outcomes (e.g., over 100) for each combination of demographic characteristics.

After the test set of prompts 204 has been generated, they may be input into the large language model 206 as described for FIG. 1. Thus, the large language model 206 processes each prompt, tokenizing the input and using its transformer architecture with self-attention mechanisms to understand contextual relationships. The LLM processes the prompts through multiple neural network layers and applies transformations based on learned weights. In the output phase, the tokens are converted back into text through an iterative word generation process using probability distributions to determine the next word in the sequence. This process continues until a stop signal or maximum length is reached, resulting in the generated answers 208.

The classifier 210 may analyze the generated set of answers 208 using natural language processing techniques. In various examples, the classifier 210 may be implemented as a sentiment machine learning model to categorize the responses (for a given set of demographic characteristics) into a first group and a second group. The classifier 210 may process each answer in the generated answers 208 according to the query specified in the prompt template 202. For instance, if the query asks, “Should this person be given a job interview?” classifier 210 may categorize the answers as positive sentiment (yes) or negative sentiment (no).

The bias calculation 214 (e.g., which may be an implementation of bias metric component 120 of FIG. 1) may utilize the query target metric 212 and the distribution or total number of positive/negative answers from the classifier 210 to generate a bias metric 216 for the large language model 206. In various examples, the query target metric 212 may represent an expected or desired distribution of responses for a particular combination of demographic characteristics. The query target metric 212 may be derived from historical data or established fairness criteria. In various examples, the query target metric 212 may be represented as a historical percentage of answers having a positive sentiment for a given type and value (e.g., gender: female) of a demographic characteristic.

The bias calculation 214 may compare the distribution of positive classified generated answers to the query target metric to determine if there is a deviation that may indicate bias. For example, bias calculation 214 may calculate the percentage of generated answers in the first group compared to the total number of answers in the first group and second group. If it is determined that the percentage exceeds a value (e.g., the query target metric 212), the bias metric (e.g., bias metric 216) for the LLM may be updated.

The bias metrics may be presented in various formats to indicate the degree of bias detected in the large language model's responses. In various examples, a color-coded system may be used where green indicates the calculated percentage is within 5% of the query target metric, suggesting low bias; yellow indicates the percentage is between 5-15% of the target metric, suggesting moderate bias; and red indicates a deviation of more than 15% from the target metric, suggesting high bias. Alternatively, a standard deviation approach may be employed, where the bias metric is expressed in terms of standard deviations from the expected distribution. For instance, a bias metric within one standard deviation may be acceptable, while metrics beyond two or three may indicate significant bias. The bias metric may also be presented as a numerical scale from 0 to 100, where 0 represents no bias, and 100 represents extreme bias. In some examples, the bias metric may be expressed as the percentage difference between the observed distribution and the query target metric.

In various examples, an LLM may have multiple bias metrics, each corresponding to a specific demographic characteristic and an overall bias metric that aggregates these individual metrics. The individual bias metrics may be calculated using previously described methods, such as comparing the distribution of positive/negative responses for each demographic group to the query target metric.

For each demographic characteristic (e.g., gender, age, race, etc.), a separate bias metric may be generated. These individual metrics may use the same format as the overall bias metric, such as a color-coded system, standard deviation approach, or numerical scale. For instance, an LLM may have a gender bias metric of “yellow” (indicating moderate bias), an age bias metric of “green” (indicating low bias), and a racial bias metric of “red” (indicating high bias).

The overall bias metric for the LLM may be calculated using various statistical methods to combine the individual bias metrics. In some examples, a simple average of the individual metrics may be used. Alternatively, a weighted average may be employed, assigning different importance to various demographic characteristics based on their relevance to the specific use case or regulatory requirements.

In various examples, method 200 may be repeated with different levels of weighting applied to the layers of the machine learning model and for different models. This iterative process results in a database containing multiple bias ratings for multiple models, each trained with various training data sets and having different layer weight configurations. The bias metrics generated through this process may be stored in a database, with each entry including a base model identifier, a training data set identifier, a layer weighting configuration (e.g., 0 weighting for the last three layers), and a type of bias rating (e.g., overall, gender, age).

The database may allow for analysis of how different layer weightings and training data sets impact various types of bias in the model outputs. For instance, it may reveal that certain layer configurations are more prone to specific types of bias. In contrast, others may show improved performance in terms of fairness across different demographic categories. The stored bias metrics may be used to compare different models and training approaches, potentially identifying effective strategies for minimizing bias across various demographic categories.

FIG. 3 is a block diagram illustrating operations to generate a hallucination metric for a machine learning model, according to various examples. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which, when executing the set of instructions, may configure the processing unit to perform the operations described in FIG. 3. The processing unit may instruct another component of a computing device to carry out the set of instructions. For example, the processing unit may instruct a network device to transmit data to another computing device, or the computing device may provide data over a display interface to present a user interface. In some examples, the method's performance may be split across multiple computing devices using a shared computing infrastructure.

The operations may be performed automatically after a LLM has been trained. For example, a base model may have had a fine-tuning operation performed on it using the training data set 302, and after the weights are updated, method 300 may be performed.

In various examples, the training data set 302 may include corpora of documents categorized by domain or source. For example, there may be a corpus of financial documents from a first source, a corpus of medical documents from the first source, and a corpus of medical documents from a second source. Method 300 may include generating text embeddings at various levels of granularity using parts of a corpus, the entire corpus, or multiple corpora. In some examples, the embeddings may be domain-specific. For example, in FIG. 3, three embeddings are illustrated: domain embedding 304, domain embedding 306, and domain embedding 308.

The text embeddings of the training data set 302 may be generated through various natural language processing techniques. In various examples, the process may involve tokenizing the text from the training documents into individual words or subwords. These tokens may then be converted into numerical vectors using word-to-vector (word2vec), Global Vectors for Word Representation (GloVe), or transformer-based models. The resulting vectors represent the semantic meaning of the words in a high-dimensional space. In various examples, the embedding generation process may incorporate techniques to handle domain-specific terminology, acronyms, and jargon, such as custom vocabularies to ensure that domain-specific terms are adequately represented in the embedding space. For domain-specific embeddings, the embedding model may be trained or fine-tuned on the specific corpus of documents relevant to that domain.

The test set of prompts 310 may be stored in a database (e.g., in data store 116 of FIG. 1) and include prompts for evaluating hallucination may include a variety of knowledge or document recall prompts designed to elicit answers that should contain information from the training data set 302. For example, the prompts may be structured to query specific facts, concepts, or relationships present in the training data corpus. This could include prompts asking for definitions of domain-specific terms, summaries of documents, or explanations of processes described in the training data. The test set of prompts 310 may also incorporate prompts that require the model to use information from multiple sources within the training data. In various examples, a test prompt is stored as associated with a domain (e.g., in a domain column of a database).

The test set of prompts 310 may be input to large language model 312 to output generated answers 314. The answer embeddings 316 may be generated from the generated answers 314. The answer embeddings 316 may be text embeddings of the same dimensionality as the domain embeddings of training data set 302.

In various examples, when an answer embedding is generated from generated answers 314, the answer embedding may be compared (using a cosine similarity metric) to the domain embeddings derived from the training data set 302. If a specific domain is associated with the answer embedding (due to the test prompt's stored domain), hallucination calculation 318 may prioritize comparison with the corresponding domain embedding. For instance, if the answer pertains to financial information, it may be primarily compared to the financial domain embedding. However, in various examples, the answer embedding may be compared to more than one domain embedding.

The hallucination metric 320 may be generated through various methods. For example, a threshold-based method may be used. Thus, if at least one of the generated cosine similarity metrics for a given answer exceeds a predetermined threshold (e.g., above 0.8) of similarity to at least one domain embedding, the answer may be classified as not likely to be hallucinated.

The percentage of such non-hallucination comparisons across a set of generated answers may be the basis for an overall hallucination metric. In other examples, domain-specific hallucination metrics may be generated. This approach may involve calculating separate hallucination metrics for different domains represented in the training data set 302. For instance, there may be distinct hallucination metrics for financial, medical, and legal domains.

The cosine similarity calculation between answer embeddings 316 and domain embeddings may quantitatively measure how closely the generated answers align with the domain-specific knowledge represented in training data set 302. A higher similarity score may indicate that the large language model 312 output is more consistent with the training data, potentially suggesting a lower likelihood of hallucination. Conversely, a lower similarity score might suggest that the large language model 312 output deviates more significantly from the training data set 302, potentially indicating a higher risk of hallucination.

The hallucination metric 320 may be presented using various formats to indicate the degree of potential hallucination detected in the large language model's responses, similar to the approach described for the bias metric in FIG. 2. For example, a color-coded system may be used where green indicates a high cosine similarity (e.g., 0.9 to 1.0) suggesting low likelihood of hallucination, yellow indicates moderate similarity (e.g., 0.7 to 0.9) suggesting moderate risk, and red indicates low similarity (e.g., below 0.7) suggesting high risk of hallucination.

Alternatively, a standard deviation approach may express the hallucination metric 320 metric in terms of deviations from an expected similarity distribution, with within one standard deviation considered acceptable, one to two deviations indicating moderate concern, and beyond two deviations suggesting significant hallucination risk. The hallucination metric 320 may also be presented as a percentage value, representing the proportion of generated answers 314 falling within an acceptable similarity range to the domain embeddings. Multiple representations of the hallucination metric 320 may be presented in various examples.

In various examples, method 300 may be repeated with different levels of weighting applied to the layers of the machine learning model. This iterative process may result in a database containing multiple hallucination ratings for multiple models, each trained with various training data sets and having different layer weight configurations. The hallucination metrics generated through this process may be stored in a database, with each entry including a base model identifier, a training data set identifier, a layer weighting configuration (e.g., 0 weighting for the last three layers), and a domain-specific hallucination rating.

The database may allow for analysis of how different layer weightings and training data sets impact hallucinations across various domains in the model outputs. For instance, it may reveal that certain layer configurations are more prone to hallucinations in specific domains. In contrast, others may show improved performance in terms of accuracy across different domain-specific knowledge areas.

FIG. 4 is a large language model metric user interface 402, according to various examples. The user interface 402 may be presented on a computing device such as client device 104 of FIG. 1 as served from web server 108. The information header 404 may include a model identification and a training set identifier. These identifiers may correlate to identifiers in a database. In various examples, a human-readable name and a unique identifier may exist for each model and training set.

The user interface 402 may include a menu 430 that allows users to select different models and training data sets. When a user selects a new model, the user interface 402 may be updated to display metrics calculated for the selected model and training data set combination. The model may be a base model, and the training data set may be a fine-tuning data set, in some examples.

The user interface 402 may display multiple metrics, with the number of metrics shown being variable. For example, the interface may include separate metrics for gender bias and age bias based on calculations performed as described in relation to FIG. 2. The metrics may be presented using various graphical representations to convey the level of risk or severity associated with each metric.

One such representation may be a bias rating graphic 406 presented as a ring interface. The shading or fill of the ring may indicate a relative rating, such as a percentage. For example, a 50% shaded ring may signify that the model has a medium risk of overall bias. Another bias rating graphic 408 may use a different visual representation to show a high bias metric, potentially indicating that using a particular training data set has lowered the risk of bias.

The interface may employ a different visual style for hallucination metrics, such as a stoplight-style graphic 410. In this representation, the shading of different sections (e.g., red, yellow, green) may indicate the level of risk for hallucinations. For instance, if the middle (yellow) section is shaded, it may indicate that the model has a medium level of risk for hallucinations.

The system may generate these graphical representations based on the underlying bias and hallucination metrics calculated for the specific model and training data set combination. There may be a stored mapping between how a metric is stored in the database and what type of graphic should be displayed. The system may use a ring graphic with shading proportional to the percentage value for metrics stored as percentages. The system may employ a stoplight-style graphic for metrics stored as categorical values (e.g., low, medium, high risk).

In various examples, retrieving metrics and generating graphics may include several operations. For example, when a user selects a model and training data set combination through menu 430, the system (e.g., application server 102 of FIG. 1) may query a database (e.g., data store 116 using the corresponding identifiers. The database may contain pre-calculated metrics for various combinations of models, training data sets, and layer weightings, as described in relation to FIG. 2 and FIG. 3.

Upon retrieving the relevant metrics, the system may process this data to determine the appropriate visual representation. For percentage-based metrics, such as bias rating graphic 406, the system may calculate the proportion of the ring to be shaded based on the retrieved value. For categorical metrics, such as hallucination metric graphic 410, the system may use a lookup table to determine which section of the stoplight graphic should be highlighted.

The graphics generation process may utilize scalable vector graphics (SVG) or other dynamic rendering techniques to ensure the visualizations are responsive and adapt to different screen sizes and resolutions. This approach may allow smooth animations when updating the graphics in response to user interactions, such as selecting a new model or training data set.

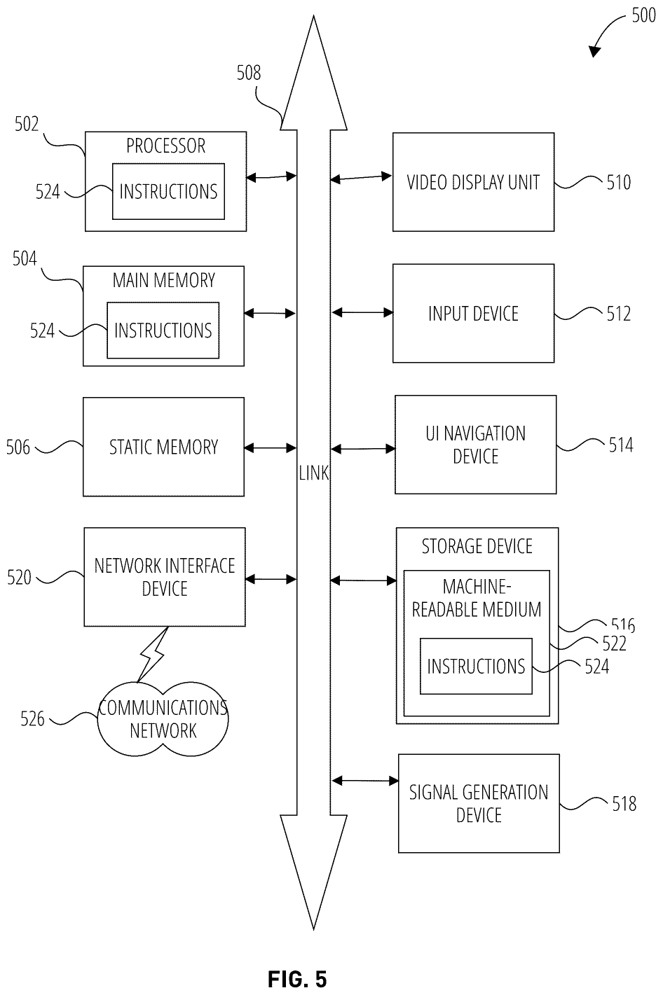

FIG. 5 is a block diagram illustrating a machine in the example form of computer system 500, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein

Example computer system 500 includes at least one processor 502 (e.g., a central processing unit (CPU), a graphics processing unit (GPU) or both, processor cores, compute nodes, etc.), a main memory 504, and a static memory 506, which communicate with each other via a link 508. The computer system 500 may include a video display unit 510, an input device 512 (e.g., a keyboard), and a user interface UI navigation device 514 (e.g., a mouse). In an example, the video display unit 510, input device 512, and UI navigation device 514 are incorporated into a single device housing, such as a touchscreen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensors.

The storage device 516 includes a machine-readable medium 522 on which one or more sets of data structures and instructions 524 (e.g., software) embodying or utilized by any of the methodologies or functions described herein. The instructions 524 may also reside, completely or at least partially, within the main memory 504, the static memory 506, or within the processor 502 during execution thereof by the computer system 500, with the main memory 504, the static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database or associated caches and servers) that store the instructions 524. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 522 that excludes transitory signals.

The instructions 524 may be transmitted or received over a communications network 526 using a transmission medium via the network interface device 520 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
generating a test set of prompts;
executing a generative artificial intelligence (GenAI) machine learning model using the test set of prompts;
in response to the executing, receiving a plurality of generated answers;
classifying the plurality of generated answers into a first group and a second group;
calculating a percentage of generated answers in the first group compared to a total number of answers of the first group and second group;
determining the percentage exceeds a value;
based on the determining, updating a bias metric the GenAI machine learning model; and
presenting the bias metric on a user interface.

2. The method of claim 1, wherein generating the test set of prompts includes:
accessing a base prompt template, the base prompt template including a demographic characteristic field; and
modifying the demographic characteristic field in the base prompt template to include a type of the demographic characteristic.

3. The method of claim 1, wherein classifying the plurality of generated answers into the first group and the second group includes, for an answer in the plurality of generated answers:
classifying, using a natural language processor, the answer as having a positive sentiment.

4. The method of claim 3, wherein determining the percentage exceeds a value includes:
querying a database for a historical percentage of answers having a positive sentiment; and
using the historical percentage as a basis for the value.

5. The method of claim 1, further comprising:
generating a first text embedding of an answer in the plurality of generated answers;
generating a second text embedding of a training data set used for training the GenAI machine learning model;
calculating a cosine similarity metric between the first text embedding and the second text embedding; and
updating a hallucination metric for the GenAI machine learning model based on the cosine similarity metric.

6. The method of claim 5, wherein the training data set is a first training data set and has a stored categorization of a first domain.

7. The method of claim 6, further comprising:
generating a third text embedding of a second training data set used for training the GenAI machine learning model, the second training data set having a stored categorization of a second domain;
calculating a cosine similarity metric between the first text embedding and the third text embedding; and
updating the hallucination metric for the GenAI machine learning model based on the cosine similarity metric between the first text embedding and the third text embedding.

8. The method of claim 1, wherein the GenAI machine learning model includes a transformer layer.

9. A system comprising:
a processing unit; and
a storage device comprising instructions, which when executed by the processing unit, configure the processing unit to perform operations comprising:
generating a test set of prompts;
executing a generative artificial intelligence (GenAI) machine learning model using the test set of prompts;
in response to the executing, receiving a plurality of generated answers;
classifying the plurality of generated answers into a first group and a second group;
calculating a percentage of generated answers in the first group compared to a total number of answers of the first group and second group;
determining the percentage exceeds a value;
based on the determining, updating a bias metric the GenAI machine learning model; and
presenting the bias metric on a user interface.

10. The system of claim 9, wherein generating the test set of prompts includes:
accessing a base prompt template, the base prompt template including a demographic characteristic field; and
modifying the demographic characteristic field in the base prompt template to include a type of the demographic characteristic.

11. The system of claim 9, wherein classifying the plurality of generated answers into the first group and the second group includes, for an answer in the plurality of generated answers:
classifying, using a natural language processor, the answer as having a positive sentiment.

12. The system of claim 11, wherein determining the percentage exceeds a value includes:
querying a database for a historical percentage of answers having a positive sentiment; and
using the historical percentage as a basis for the value.

13. The system of claim 9, wherein the instructions, which when executed by the processing unit, further configure the processing unit to perform operations comprising:
generating a first text embedding of an answer in the plurality of generated answers;
generating a second text embedding of a training data set used for training the GenAI machine learning model;
calculating a cosine similarity metric between the first text embedding and the second text embedding; and
updating a hallucination metric for the GenAI machine learning model based on the cosine similarity metric.

14. The system of claim 13, wherein the training data set is a first training data set and has a stored categorization of a first domain.

15. The system of claim 14, wherein the instructions, which when executed by the processing unit, further configure the processing unit to perform operations comprising:
generating a third text embedding of a second training data set used for training the GenAI machine learning model, the second training data set having a stored categorization of a second domain;
calculating a cosine similarity metric between the first text embedding and the third text embedding; and
updating the hallucination metric for the GenAI machine learning model based on the cosine similarity metric between the first text embedding and the third text embedding.

16. The system of claim 9, wherein the GenAI machine learning model includes a transformer layer.

17. A non-transitory computer-readable medium comprising instructions, which when executed by a processing unit, configure the processing unit to perform operations comprising:
generating a test set of prompts;
executing a generative artificial intelligence (GenAI) machine learning model using the test set of prompts;
in response to the executing, receiving a plurality of generated answers;
classifying the plurality of generated answers into a first group and a second group;
calculating a percentage of generated answers in the first group compared to a total number of answers of the first group and second group;
determining the percentage exceeds a value;
based on the determining, updating a bias metric the GenAI machine learning model; and
presenting the bias metric on a user interface.

18. The non-transitory computer-readable medium of claim 17, wherein generating the test set of prompts includes:
accessing a base prompt template, the base prompt template including a demographic characteristic field; and
modifying the demographic characteristic field in the base prompt template to include a type of the demographic characteristic.

19. The non-transitory computer-readable medium of claim 17, wherein classifying the plurality of generated answers into the first group and the second group includes, for an answer in the plurality of generated answers:
classifying, using a natural language processor, the answer as having a positive sentiment.

20. The non-transitory computer-readable medium of claim 19, wherein determining the percentage exceeds a value includes:
querying a database for a historical percentage of answers having a positive sentiment; and
using the historical percentage as a basis for the value.
